(19) United States
(12) Patent Application Publication
(10) Pub. No.: US 2006/0186858 A1
(43) Pub. Date: Aug. 24, 2006

(54) Charging apparatus

(75) Inventors: Eric Wang, Taipei Hsien (TW); Ming-Chung Wang, Taipei Hsien (TW)

Correspondence Address: DARBY & DARBY P.C., P. O. BOX 5257, NEW YORK, NY, 10150-5257, US

(73) Assignee: Advanced Connection Technology Inc., Taipei Hsien (TW)

(21) Appl. No.: 11/317,967

(22) Filed: Dec. 23, 2005

(30) Foreign Application Priority Data
Feb. 18, 2005 (TW) 094104853

(51) Int. Cl. H02J 7/00

(52) U.S. Cl. 320/128

(57) ABSTRACT

A charging apparatus includes a device-specific bridging unit and a charging unit. The bridging unit is coupled electrically and removably to a charging port of an electronic device, and is operable so as to provide charging information that is specific to the electronic device. The charging unit is coupled electrically and removably to the bridging unit, and is operable so as to generate a charging signal that is based on the charging information received from the bridging unit and that is to be supplied to the electronic device through the bridging unit.

### CROSS-REFERENCE TO RELATED APPLICATION

This application claims priority of Taiwanese application no. 094104853, filed on Feb. 18, 2005.

### BACKGROUND OF THE INVENTION

1. Field of the Invention

This invention relates to a charging apparatus, more particularly to a charging apparatus that is capable of charging different electronic devices.

2. Description of the Related Art

Portable electronic devices, such as personal digital assistants (PDA), mobile phones, MP3 players, digital still cameras, digital video cameras, notebook computers, etc., are prevalently employed everywhere. Each electronic device requires its own specific electrically and mechanically matched charging unit. If the electronic devices are to be used outdoors or are to be taken on a business trip, it is often necessary to bring along the requisite different charging units. This impairs the portability of the electronic devices.

### SUMMARY OF THE INVENTION

Therefore, the object of the present invention is to provide a charging apparatus that can overcome the aforesaid drawback of the prior art.

According to the present invention, a charging apparatus, which is adapted for charging an electronic device that has a, charging port, comprises a device-specific bridging unit and a charging unit. The bridging unit is adapted to be coupled electrically and removably to the charging port of the electronic device, and is operable so as to provide charging information that is specific to the electronic device. The charging unit is coupled electrically and removably to the bridging unit, and is operable so as to generate a charging signal that is based on the charging information received from the bridging unit and that is to be supplied to the electronic device through the bridging unit.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram of the preferred embodiment of a charging apparatus according to the present invention;

FIG. 2 is a schematic circuit diagram of an information module of the preferred embodiment;

FIG. 3 is a schematic circuit diagram of an information module of an alternative embodiment of a charging apparatus according to this invention; and

FIG. 4 is a schematic circuit diagram of the preferred embodiment.

### DETAILED DESCRIPTION OF THE PREFERRED EMBODIMENT

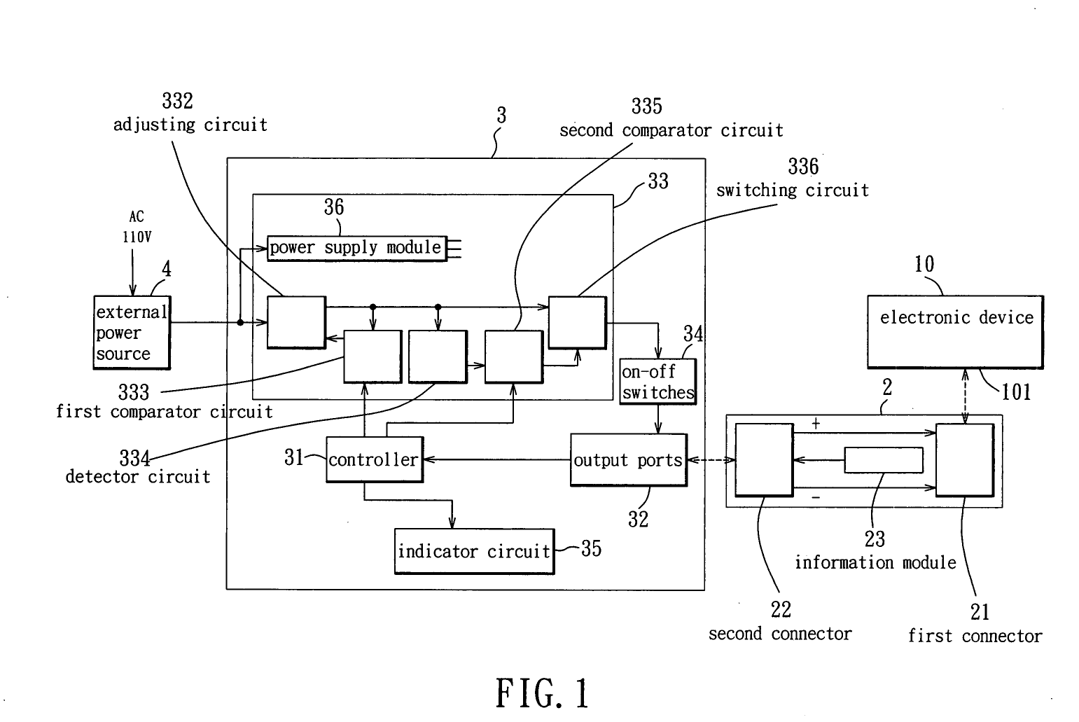

Referring to FIG. 1, the preferred embodiment of a charging apparatus according to this invention is shown to include a device-specific bridging unit 2 and a charging unit 3.

The charging apparatus of this embodiment is capable of charging different electronic devices 10, in a manner that will be described hereinafter.

The bridging unit 2 includes first and second connectors 21, 22, and an information module 23. The first connector 21 of the bridging unit 2 is connected electrically and removably to a charging port 101 of the electronic device 10. The second connector 22 of the bridging unit 2 is connected electrically to the first connector 21 of the bridging unit 2. The information module 23 of the bridging unit 2 is connected electrically to the second connector 22 of the bridging unit 10, and is operable so as to provide charging information, which is specific to the electronic device 10, to the second connector 22 of the bridging unit 2. In this embodiment, the charging information includes both voltage-related information, which contains a charging voltage required by the electronic device 10, and current-related information, which contains a maximum charging current that the electronic device 10 can handle.

The charging unit 3 of this embodiment includes an output port unit, a controller 31, and a power converter 33.

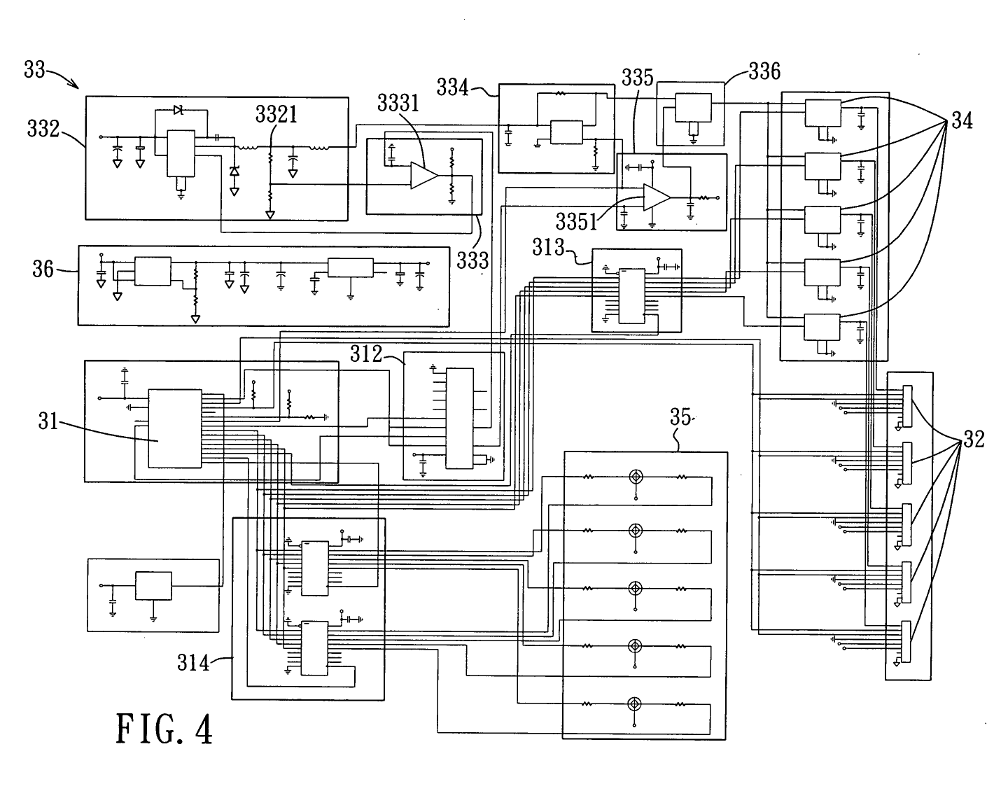

The output port of the charging unit 3 has five output ports 32 (see FIG. 4), one of which is hereinafter referred to as the connected output port 32. In this embodiment, the connected output port 32 of the charging unit 3 is connected electrically and removably to the second connector 22 of the bridging unit 2.

The power converter 33 of the charging unit 3 includes an adjusting circuit 332, first and second comparator circuits 333, 335, a detector circuit 334, and a switching circuit 336.

The adjusting circuit 332 of the power converter 33 is connected electrically and removably to a transformer of an external power source 4. The first comparator circuit 333 of the power converter 33 is connected electrically to the adjusting circuit 332 of the power converter 33. The detector circuit 334 of the power converter 33 is connected electrically to the adjusting circuit 332 of the power converter 33. The second comparator circuit 335 of the power converter 33 is connected electrically to the detector circuit 334 of the power converter 33. The switching circuit 336 of the power converter 33 is connected electrically to the adjusting circuit 332 and the second comparator circuit 335 of the power converter 33.

The charging unit 3 further includes five on-off switches 34 (see FIG. 4), each of which corresponds to a respective one of the output ports 32, and each of which is connected electrically to the switching circuit 336 of the power converter 33 and the respective one of the output ports 32.

The controller 31 is connected electrically to the first and second comparator circuits 333, 335 of the power converter 33, and the output ports 32.

In operation, when the adjusting unit 332 of the power converter 33 is connected to the external power source 4, and when the first and second connectors 21, 22 of the bridging unit 2 are respectively connected to the charging port 101 of the electronic device 10 and the connected output port 32 of the charging unit 3, the adjusting circuit 332 of the power converter 33 generates a charging signal from power supplied by the transformer of the external power source 4. At the same time, the controller 31 detects the charging information provided to the connected output port 32. In response to the charging information, the controller 31 activates the on-off switch 34 that corresponds to the connected output port 32, deactivates the rest of the on-off switches 34, and generates reference and threshold values, each of which respectively corresponds to the charging voltage and the maximum charging current contained in the charging information detected thereby. The first comparator circuit 333 of the power converter 33 then compares a voltage component of the charging signal generated by the adjusting circuit 332 of the power converter 33 to the reference value generated by the controller 31, and provides a comparison result to the adjusting circuit 332 of the power converter 33. The adjusting circuit 332 of the power converter 33 adjusts the voltage component of the charging signal that is generated thereby based on the comparison result such that the voltage component of the charging signal matches the charging voltage contained in the charging information. The charging signal is supplied to the electronic device 10 through the switching circuit 336 of the power converter 33, the activated on-off switch 34, the connected output port 32, and the first and second connectors 21, 22 of the bridging unit 2.

Furthermore, the detector circuit-334 of the power converter 33 detects a current component of the charging signal generated by the adjusting circuit 332 of the power converter 33. The second comparator circuit 335 of the power converter 33 then compares the current component of the charging signal detected by the detector circuit 334 of the power converter 33 to the threshold value generated by the controller 31, and provides a comparison result to the switching circuit 336 of the power converter 33. When the current component of the charging signal is higher than the threshold value, the switching circuit 336 of the power converter 33 breaks electrical connection between the adjusting circuit 333 of the power converter 33 and the connected output port 32, thereby inhibiting supply of the charging signal to the electronic device 10. As such, the electronic device 10 is protected from overload current. On the other hand, when the current component of the charging signal is lower than the threshold value, the switching circuit 336 of the power converter 33 maintains the electrical connection between the adjusting circuit 332 of the power converter 33 and the connected output port 32.

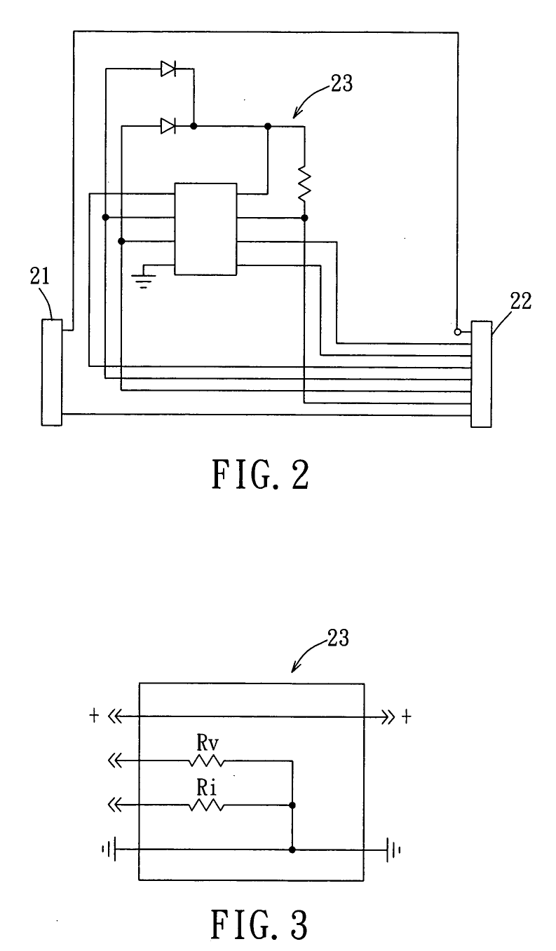

In this embodiment, with further reference to FIG. 2, the information module 23 of the bridging unit 2 includes a memory device that stores the charging information. The controller 31 of the charging unit 3 detects the charging information by performing a read operation on the memory device.

In an alternative embodiment, with further reference to FIG. 3, the information module 23 of the bridging unit 2 includes a pair of resistors (Rv, Ri). The controller 31 of the charging unit 3 detects the charging information by determining the values of the resistors (Rv, Ri) based on a voltage across and a current flowing through each of the resistors (Rv, Ri).

In this embodiment, the transformer of the external power source 4 converts a 110 alternating current (AC) voltage from an AC commercial power line into a 4.5 direct current voltage. In an alternative embodiment, the transformer of the power source 4 converts the 110 AC voltage from the AC commercial power line into a direct current voltage ranging between 12- to 30-Volts.

It is noted that when the charging unit 3 is connected to two or more of the electronic devices 10, the charging unit 3 charges the electronic devices 10 in an alternating sequence. That is, the controller 31 detects the charging information by polling the output ports 32, and activates the on-off switch 34 that corresponds to the output port 32 currently polled by the controller 31 while deactivating the rest of the on-off switches 34. As such, the controller 31 ensures that the charging signals generated by the charging unit 3 at different times are suitable for the different electronic devices 10. In this embodiment, the charging unit 3 alternately charges the electronic devices 10 at five-minute intervals.

Although the charging unit 3 is exemplified using five output ports 32, it should be apparent to those skilled in the art that the number of the output ports 32 may be increased or reduced as required.

Referring to FIG. 4, in this embodiment, the adjusting circuit 332 of the power converter 33 further includes a voltage divider 3321 for dividing the voltage component of the charging signal generated by the adjusting circuit 332 of the power converter 33. The first comparator circuit 333 of the power converter 33 includes a comparator 3331 that has a non-inverting input connected electrically to a center tap of the voltage divider 3321 of the adjusting circuit 332 for detecting a voltage output of the voltage divider 3321, and an inverting input for receiving the reference value from the controller 31. When the voltage output is less than the reference value, the comparator 3331 of the first comparator circuit 333 of the power converter 33 generates a low logic level output, which enables the adjusting unit 332 of the power converter 33 to increase the voltage component of the charging signal. On the other hand, when the voltage output is greater than the reference value, the comparator 3331 of the first comparator circuit 333 of the power converter 3331 generates a high logic level output, which enables the adjusting unit 332 of the power converter 33 to decrease the voltage component of the charging signal.

The detector circuit 334 of the power converter 33 generates a voltage output that corresponds to the current component of the charging signal detected thereby. The second comparator circuit 335 of the power converter 33 includes a comparator 3351 that has an inverting input connected electrically to the detector circuit 334 for detecting the voltage output, and a non-inverting input for receiving the threshold value from the controller 31. When the voltage output is greater than the threshold value, the comparator 3351 of the second comparator circuit 335 of the power converter 33 generates a low logic level output to enable the switching circuit 336 of the power converter 33 to break the electrical connection between the adjusting circuit 332 of the power converter 33 and the polled output port 32. On the other hand, when the voltage output is less than the threshold value, the comparator 3351 of the second comparator circuit 335 of the power converter 33 generates a high logic level output to enable the switching circuit 336 of the power converter 33 to maintain the electrical connection between the adjusting circuit 332 of the power converter 33 and the polled output port 32.

The controller 31 of the charging unit 3 has a plurality of output pins, two of which are hereinafter referred to as the first and second output pins. The reference and threshold values generated by the controller 31 are supplied at the first and second output pins thereof. The charging unit 3 further includes a controlled switch 312 that is connected electrically to the first and second output pins of the controller 31, the inverting input of the comparator 3331 of the first comparator circuit 333 of the power converter 33, and the non-inverting input of the comparator 3351 of the second comparator circuit 335 of the power converter 33. The controlled switch 312 is further connected to a control pin of the controller 31 and is controlled by the controller 31 so as to connect each of the first and second output pins of the controller 31 to a respective one of the non-inverting input of the comparator 3331 of the first comparator circuit 333 of the power converter 33 and the non-inverting input of the comparator 3351 of the second comparator circuit 335 of the power converter 33 within predetermined intervals.

The charging unit 3 further includes a first driving circuit 313. A shared portion of the output pins of the controller 31 is coupled electrically to the on-off switches 34 via the first driving circuit 313.

The charging unit 3 further includes a second driving circuit 314 and an indicator circuit 35. The indicator circuit 35 includes five light-emitting diodes. The shared portion of the output pins of the controller 31 is further coupled electrically to the light-emitting diodes of the indicator circuit 35 via the second driving circuit 314. Each of the output ports 32 corresponds to a respective one of the light-emitting diodes of the indicator circuit 35. That is, each of the light-emitting diodes of the indicator circuit 35 is controlled by the controller 31 so as to give off light when the output port 32 that corresponds to the light-emitting diode is connected to the second connector 22 (see FIG. 1) of the bridging unit 2 (see FIG. 1). Furthermore, each of the light emitting diodes of the indicating circuit 35 is further controlled by the controller 31 so as to give off different colors of light to indicate charging status of the electronic devices 10.

In an alternative embodiment, the controller 31, the controlled switch 312, and the first and second driving circuits 313, 314 may be implemented using a single microprocessor.

The charging unit 3 further includes a power supply module 36 that is connected electrically and removably to the transformer of the external power source 4. In this embodiment, the power supply module 36 converts the power from the transformer of the external power source 4 into a 3.3 direct current voltage that is supplied to the controller 31, the adjusting circuit 332 of the power converter 33, the comparators 3321, 3351 of the first and second comparator circuits 333, 335 of the power converter 33, the switching circuit 336 of the power converter 33, the controlled switch 312, and the first and second driving circuits 313, 314.

In an alternative embodiment, the power supply module 36 of the charging unit 3 includes the transformer of the external power source 4.

It has thus been shown that the charging apparatus of this invention includes a device-specific bridging unit 2 and a charging unit 3. The bridging unit 2 is connected electrically and removably to an electronic device 10, and is operable so as to provide charging information that is specific to the electronic device 10. The charging unit 3 is connected electrically and removably to the bridging unit 2, and is operable so as to generate a charging signal that is based on the charging information and that is supplied to the electronic device 10 through the bridging unit 2. The arrangement as such permits charging of different electronic devices 10 by providing different bridging units 2 and a single charging unit 3.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A charging apparatus adapted for charging an electronic device that has a charging port, said charging apparatus comprising:
a device-specific bridging unit adapted to be coupled electrically and removably to the charging port of the electronic device, and operable so as to provide charging information that is specific to the electronic device; and
a charging unit coupled electrically and removably to said bridging unit, and operable so as to generate a charging signal that is based on the charging information received from said bridging unit and that is to be supplied to the electronic device through said bridging unit.

2. The charging apparatus as claimed in claim 1, wherein said bridging unit includes a first connector that is adapted to be connected electrically to the charging port of the electronic device, a second connector that is coupled to said first connector, and an information module that is coupled to said second connector and that provides the charging information to said second connector.

3. The charging apparatus as claimed in claim 2, wherein said charging unit includes
an output port that is coupled removably to said second connector of said bridging unit,
a power converter coupled to said output port, and operable so as to generate the charging signal that is to be supplied to the electronic device via said output port and said bridging unit, and
a controller coupled to said output port and said power converter, and operable so as to detect the charging information provided by said information module via said output port and said second connector and so as to control said power converter to generate the charging signal based on the charging information.

4. The charging apparatus as claimed in claim 3, wherein said controller is further operable so as to generate a reference value that corresponds to the charging information detected thereby, said power converter including
an adjusting circuit that is adapted to be coupled to an external power source, and that is operable so as to generate the charging signal from power supplied by the external power source, and
a first comparator circuit that is coupled to said controller and said adjusting circuit, and that is operable so as to compare the charging signal generated by said adjusting circuit to the reference value generated by said controller and so as to provide a comparison result to said adjusting circuit, said adjusting circuit adjusting the charging signal generated thereby based on the comparison result.

5. The charging apparatus as claimed in claim 4, wherein said controller further generates a threshold value that corresponds to the charging information detected thereby, said power converter further including
a detector circuit that is coupled to said adjusting circuit, and that is operable so as to detect a current component of the charging signal,
a switching circuit that is coupled between said adjusting circuit and said output port, and
a second comparator circuit that is coupled to said controller and said detector circuit, and that is operable so as to compare the current component of the charging signal detected by said detector circuit to the threshold value generated by said controller, and so as to provide a comparison result to said switching circuit, said switching circuit breaking electrical connection between said adjusting circuit and said output port when the current component of the charging signal is higher than the threshold value, thereby inhibiting supply of the charging signal to the electronic device.

6. The charging apparatus as claimed in claim 1, wherein said information module includes a memory device for storing the charging information.

7. The charging apparatus as claimed in claim 1, wherein the charging information includes at least one of voltage-related information and current-related information.

8. The charging apparatus as claimed in claim 3, wherein said charging unit further includes an indicator circuit coupled to and controlled by said controller so as to indicate a charging status.

9. A charging unit for a charging apparatus, the charging apparatus including a device-specific bridging unit that provides charging information specific to an electronic device, said charging unit comprising:
an output port adapted to be coupled to the bridging unit;
a power converter coupled to said output port, and operable so as to generate a charging signal that is based on the charging information received from the bridging unit, and that is to be supplied to the electronic device via said output port and the bridging unit; and
a controller coupled to said output port and said power converter, and operable so as to detect the charging information provided by the bridging unit via said output port and so as to control said power converter to generate the charging signal based on the charging information.

10. The charging unit as claimed in claim 9, wherein said controller is further operable so as to generate a reference value that corresponds to the charging information detected thereby, said power converter including
an adjusting circuit that is adapted to be coupled to an external power source, and that is operable so as to generate the charging signal from power supplied by the external power source, and
a first comparator circuit that is coupled to said controller and said adjusting circuit, and that is operable so as to compare the charging signal generated by said adjusting circuit to the reference value generated by said controller and so as to provide a comparison result to said adjusting circuit, said adjusting circuit adjusting the charging signal generated thereby based on the comparison result.

11. The charging unit as claimed in claim 10, wherein said controller further generates a threshold value that corresponds to the charging information detected thereby, said power converter further including
a detector circuit that is coupled to said adjusting circuit, and that is operable so as to detect a current component of the charging signal,
a switching circuit that is coupled between said adjusting circuit and said output port, and
a second comparator circuit that is coupled to said controller and said detector circuit, and that is operable so as to compare the current component of the charging signal detected by said detector circuit to the threshold value generated by said controller, and so as to provide a comparison result to said switching circuit, said switching circuit breaking electrical connection between said adjusting circuit and said output port when the current component of the charging signal is higher than the threshold value, thereby inhibiting supply of the charging signal to the electronic device.

12. The charging unit as claimed in claim 9, further comprising an indicator circuit coupled to and controlled by said controller so as to indicate a charging status.

13. A device-specific bridging unit for a charging apparatus, the charging apparatus including a charging unit that has an output port, said bridging unit comprising:
a first connector adapted to be coupled electrically and removably to a charging port of an electronic device;
a second connector coupled electrically to said first connector, and adapted to be coupled electrically and removably to the output port of the charging unit; and
an information module coupled to said second connector and operable so as to provide charging information that is specific to the electronic device to the charging unit via said second connector;
whereby, the charging unit is able to generate a charging signal that is based on the charging information received from said information module and that is supplied to the electronic device through the output port and said first and second connectors of said bridging unit.

14. The device-specific bridging unit as claimed in claim 13, wherein said information module includes a memory device for storing the charging information.

15. The device-specific bridging unit as claimed in claim 13, wherein the charging information includes at least one of voltage-related information and current-related information.
